(19) United States
(12) Patent Application Publication
(10) Pub. No.: US 2025/0341764 A1
(43) Pub. Date: Nov. 6, 2025

(54) RIM LOCK CAMERA LENS ACCESSORY MOUNT

(71) Applicant: MICHAEL THE MAVEN, LLC, Sheridan, WY (US)

(72) Inventor: Michael Shiffler, Sheridan, WY (US)

(73) Assignee: MICHAEL THE MAVEN, LLC, Sheridan, WY (US)

(21) Appl. No.: 18/831,455

(22) Filed: Jan. 24, 2025

Related U.S. Application Data
(60) Provisional application No. 63/642,721, filed on May 4, 2024.

(51) Int. Cl. G03B 17/56

(52) U.S. Cl. CPC G03B 17/566; G03B 17/565

(57) ABSTRACT

A rim lock camera accessory mount includes a connector on an attachment section that interfaces with a camera lens to secure the rim lock camera accessory mount to the camera lens. The attachment section connects to an accessory section in the rim lock camera accessory mount and may include a step between the attachment section and the accessory section. The accessory section provides an accessory which allows one or more camera filters to be installed on the camera lens and also attaches one or more accessories to the camera lens by the rim lock camera mount accessory mount.

### TECHNICAL FIELD

The disclosure relates generally to systems and devices related to attaching various accessories to a lens of a camera.

### BACKGROUND

Magnetic camera lens filters are a tremendous innovation in the art of cameras, providing the filtering of light that travels into the lens of a camera. The magnetic connection between a camera lens and a filter is often rigid and durable for use during a session of picture taking with a camera. However, magnetic camera lens filters can, under some circumstances have an inadequate connection strength to a camera lens, for better or worse.

A careful balance must be struck between a strength of a magnetic connection, measured in a unit called Newtons between two items, like a camera filter and a camera lens. If the magnetic connection is too strong (e.g., a high Newton connection), the camera filter may be very difficult to remove from the camera lens (or, more technically, the camera lens housing). At the same time, if the magnetic connection is not strong enough (e.g., a low Newton connection), the camera filter may fall off when the camera is moved slightly. Thus, having a magnetic connection that is strong enough to prevent camera lenses from falling off while also allowing a user to remove the filters as desired, requires a balance.

For most camera manufacturers and lens manufacturers, this balance is a carefully guarded secret. However, during transportation, many magnetic filters have the unpleasant habit of being bumped and becoming dislodged from the camera lens and lost. For example, if a camera operator takes a picture and then puts a camera strap attached to the camera over the operator's shoulder to walk to another location for another picture, the operator may bump the camera with the operator's hip, for example, which could cause the magnetic connection between the camera filter and the camera lens to be disrupted and cause the lens to fall off the camera. Significant bumps from any object can pose a problem in a magnetic camera filter scenario that could potentially be very expensive to the user when filters are lost.

It is, therefore, one object of this disclosure to provide a rim lock camera lens accessory mount. In one embodiment, a rim lock camera lens accessory mount may be generally circular in shape and attach to a camera lens by a tongue and groove system.

The rim lock camera lens accessory mount may include an accessory which fits over one or more filters attached to the camera lens and ensure that even if bumped, the one or more filters remain attached to the camera. In another embodiment, a rim lock camera lens accessory mount may be implemented as a lens hood. In another embodiment, a rim lock camera lens accessory mount may be implemented with a mount for attaching other accessories to the camera lens.

### SUMMARY

A rim lock camera accessory mount includes a connector on an attachment section that interfaces with a camera lens to secure the rim lock camera accessory mount to the camera lens. The attachment section connects to an accessory section in the rim lock camera accessory mount and may include a step between the attachment section and the accessory section. The accessory section provides an accessory which allows one or more camera filters to be installed on the camera lens and also attaches one or more accessories to the camera lens by the rim lock camera mount accessory mount.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a perspective view of a rim lock camera lens accessory mount.

FIG. 2 illustrates a cross sectional view of the rim lock camera lens accessory mount.

FIG. 3 illustrates a side view of the rim lock camera lens accessory connected to a camera lens.

FIG. 4 illustrates a perspective view of a rim lock camera lens accessory mount implemented as a lens hood.

FIG. 5 illustrates a perspective view of a rim lock camera lens accessory mount implemented with a separate accessory mount.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

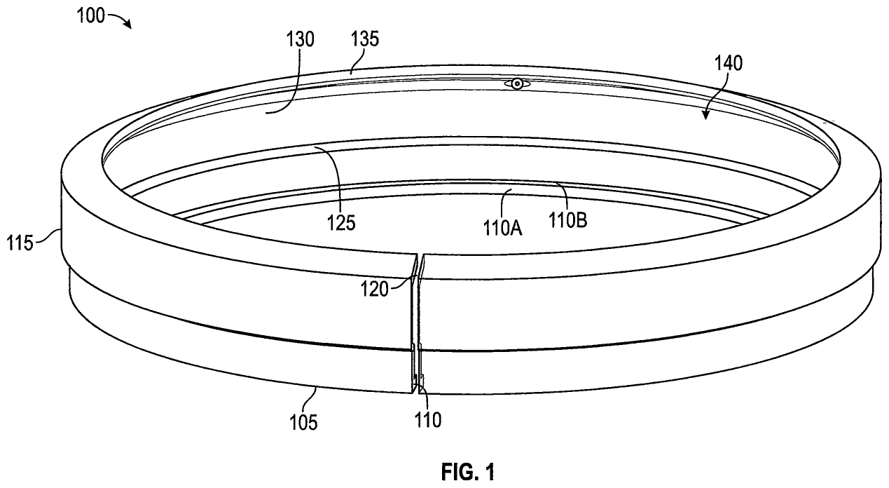

FIG. 1 illustrates a perspective view of a rim lock camera lens accessory mount 100. Rim lock camera lens accessory mount 100 may generally be circular in construction which is useful in attaching rim lock camera lens accessory mount 100 to a camera lens. It should be noted at this point that a camera lens may refer to various different elements of a camera. For example, glass in a camera lens may be considered a “camera lens.” However, by use of the word “camera lens,” herein, the intended meaning includes the entirety of a camera lens and associated housing which allows the camera lens to attach to the camera. Should the intention be to refer to just the glass of the camera lens, (e.g., the lens itself), it will be referred to as the “camera lens glass.” Since camera lenses are typically round in shape, rim lock camera lens accessory mount 100 may also be circular to attach around a circumference of a camera lens. Rim lock camera lens accessory mount 100 may be formed from synthetic materials with an element of elasticity, such as various plastics known in the art. For example, rim lock camera lens accessory mount 100 may have a particular diameter and may stretch, or separate, as will be discussed below, to attach to a camera lens having a diameter of double a resting (e.g., non-stretched or separated) diameter of rim lock camera lens accessory mount 100. Exemplary plastics may include silicone or other plastics known in the art that are suitable to stretch or separate to encompass a camera lens or at least mostly encompass a camera lens, as will be discussed below.

Rim lock camera lens accessory mount 100 may include an attachment section 105 and an accessory section 115. Attachment section 105 may further include a tongue or connector 110 (e.g., a tongue which matches a groove in a camera lens which operates as a connector between rim lock camera lens accessory mount 100 and a camera lens), that has a thickness 110A and a length 110B. Thickness 110A and length 110B may be compatible with a camera lens such that thickness 110A and length 110B correspond to a groove installed within a camera lens to secure rim lock camera lens accessory mount 100 to the camera lens. In one embodiment, thickness 110A and length 110B of tongue 110 may be commensurate with a bayonet mount, which is a type of mount known in the art of cameras. Tongue or connector 110, generally speaking, may interface with one or more corresponding elements installed on a camera lens to secure rim lock camera lens accessory mount 100 to rim lock camera lens accessory mount 100 to the camera lens.

Rim lock camera lens accessory mount 100 may include a step 125 disposed between attachment section 105 and accessory section 110. Attachment section 105 may be sized to attach to a camera lens while accessory section 115 may be fitted to accept a particular accessory 135 for a particular purpose. For example, as shown in FIG. 1, rim lock camera lens accessory mount 100 provides a filter retainer accessory 135. To facilitate accessory 135 as a filter retainer, accessory section 115 includes dimensions 130 that encompass one or more camera filters which may be attached to a camera lens in terms of both diameter and length (e.g., having a diameter that may surround or mostly surround one or more camera filters and having a length that is long enough to encompass one or more filters stacked on top of each other on the camera lens). Step 125 allows for a diameter change between attachment section 105 and accessory section 115 for this purpose.

Rim lock camera lens accessory mount 100, as discussed above includes an accessory 135, which is implemented as a filter retainer accessory. Accessory 135 may be implemented as a rim which reduces a size of aperture 140 by a small amount, which is sufficient to prevent a camera filter from falling away from a camera lens. The rim may be integral to rim lock camera lens accessory mount 100.

Rim lock camera lens accessory mount 100 may optionally include a slit 120, which allows rim lock camera lens accessory mount 100 to flex due to its elastic properties to surround or mostly surround both a camera lens and one or more filters attached to the camera lens. Slit 120 will be discussed below. However, slit 120 may be opened to a wider slit to increase a diameter of rim lock camera lens accessory mount 100 both in attachment section 105 and accessory section 115 of rim lock camera lens accessory mount 100 such that half or more of a diameter of a camera lens is surrounded by rim lock camera lens accessory mount 100.

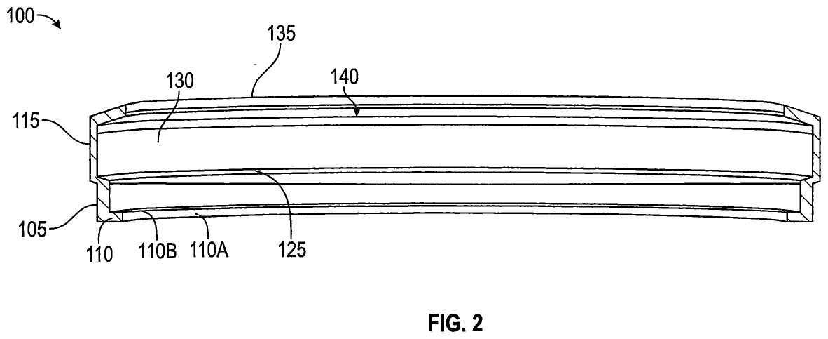

FIG. 2 illustrates a cross sectional view of rim lock camera lens accessory mount 100. As shown in FIG. 2, which shows rim lock camera lens accessory mount 100 shown in FIG. 1 as cut in half along a horizontal axis of the figure, rim lock camera lens accessory mount 100 internal elements, such as tongue or connector 110, step 125, and accessory section dimensions 130. As previously discussed, rim lock camera lens accessory mount 100 may generally be circular in construction which is useful in attaching rim lock camera lens accessory mount 100 to a camera lens. Since camera lenses are typically round in shape, rim lock camera lens accessory mount 100 may also be circular to attach around a circumference of a camera lens. Rim lock camera lens accessory mount 100 may be formed from synthetic materials with an element of elasticity, such as various plastics known in the art. For example, rim lock camera lens accessory mount 100 may have a particular diameter and may stretch, or separate, as will be discussed below, to attach to a camera lens having a diameter of double a resting (e.g., non-stretched or separated) diameter of rim lock camera lens accessory mount 100. Exemplary plastics may include silicone or other plastics known in the art that are suitable to stretch or separate to encompass a camera lens or at least mostly encompass a camera lens, as will be discussed below.

Rim lock camera lens accessory mount 100 may include an attachment section 105 and an accessory section 115. Attachment section 105 may further include a tongue or connector 110 (e.g., a tongue which matches a groove in a camera lens which operates as a connector between rim lock camera lens accessory mount 100 and a camera lens), that has a thickness 110A and a length 110B. Thickness 110A and length 110B may be compatible with a camera lens such that thickness 110A and length 110B correspond to a groove installed within a camera lens to secure rim lock camera lens accessory mount 100 to the camera lens. In one embodiment, thickness 110A and length 110B of tongue 110 may be commensurate with a bayonet mount, which is a type of mount known in the art of cameras. Tongue or connector 110, generally speaking, may interface with one or more corresponding elements installed on a camera lens to secure rim lock camera lens accessory mount 100 to rim lock camera lens accessory mount 100 to the camera lens. Tongue or connector 110 may extend around the entire diameter of attachment section 105, as shown in FIG. 2.

Rim lock camera lens accessory mount 100 may include a step 125 disposed between attachment section 105 and accessory section 110. Attachment section 105 may be sized to attach to a camera lens while accessory section 115 may be fitted to accept a particular accessory 135 for a particular purpose. For example, as shown in FIG. 1, rim lock camera lens accessory mount 100 provides a filter retainer accessory 135. To facilitate accessory 135 as a filter retainer, accessory section 115 includes dimensions 130 that encompass one or more camera filters which may be attached to a camera lens in terms of both diameter and length (e.g., having a diameter that may surround or mostly surround one or more camera filters and having a length that is long enough to encompass one or more filters stacked on top of each other on the camera lens). Step 125 allows for a diameter change between attachment section 105 and accessory section 115 for this purpose.

Rim lock camera lens accessory mount 100, as discussed above includes an accessory 135, which is implemented as a filter retainer accessory. Accessory 135 may be implemented as a rim which reduces a size of aperture 140 by a small amount, which is sufficient to prevent a camera filter from falling away from a camera lens. The rim may be integral to rim lock camera lens accessory mount 100.

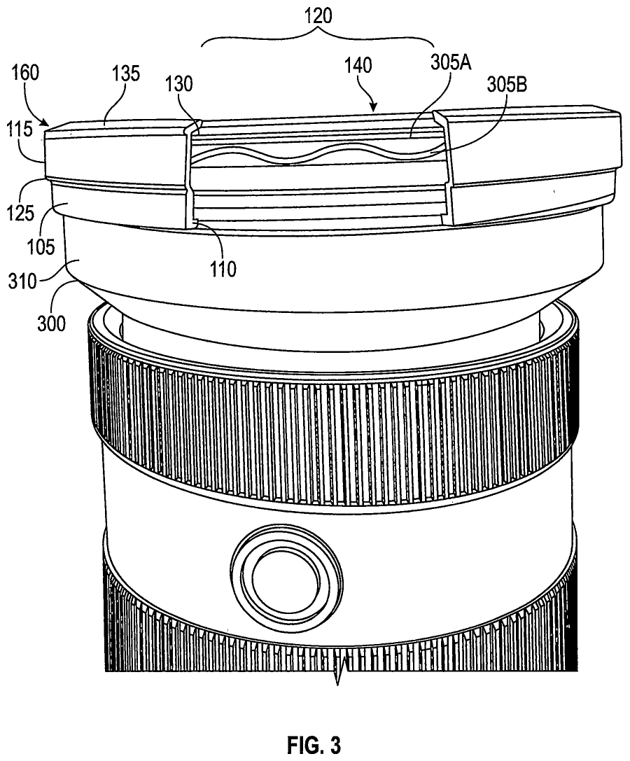

FIG. 3 illustrates a side view of rim lock camera lens accessory mount 100 connected to a camera lens 300. Rim lock camera lens accessory mount 100 may generally be circular in construction which is useful in attaching rim lock camera lens accessory mount 100 to a camera lens. Rim lock camera lens accessory mount 100 may be formed from synthetic materials with an element of elasticity, such as various plastics known in the art. For example, rim lock camera lens accessory mount 100 may have a particular diameter and may stretch, or separate, as will be discussed below, to attach to a camera lens having a diameter of double a resting (e.g., non-stretched or separated) diameter of rim lock camera lens accessory mount 100. Exemplary plastics may include silicone or other plastics known in the art that are suitable to stretch or separate to encompass a camera lens or at least mostly encompass a camera lens, as will be discussed below.

Rim lock camera lens accessory mount 100 may include an attachment section 105 and an accessory section 115. Attachment section 105 may further include a tongue or connector 110 (e.g., a tongue which matches a groove 310 in a camera lens which operates as a connector between rim lock camera lens accessory mount 100 and a camera lens), that has a thickness 110A and a length 110B. Thickness 110A and length 110B may be compatible with a camera lens such that thickness 110A and length 110B correspond to a groove 310 installed within a camera lens to secure rim lock camera lens accessory mount 100 to the camera lens. In one embodiment, thickness 110A and length 110B of tongue 110 may be commensurate with a bayonet mount 310, which is a type of mount known in the art of cameras. Tongue or connector 110, generally speaking, may interface with one or more corresponding elements installed on a camera lens to secure rim lock camera lens accessory mount 100 to rim lock camera lens accessory mount 100 to the camera lens.

Rim lock camera lens accessory mount 100 may include a step 125 disposed between attachment section 105 and accessory section 110. Attachment section 105 may be sized to attach to a camera lens while accessory section 115 may be fitted to accept a particular accessory 135 for a particular purpose. For example, as shown in FIG. 1, rim lock camera lens accessory mount 100 provides a filter retainer accessory 135. To facilitate accessory 135 as a filter retainer, accessory section 115 includes dimensions 130 that encompass one or more camera filters which may be attached to a camera lens 305A/305B in terms of both diameter and length (e.g., having a diameter that may surround or mostly surround one or more camera filters 305A/305B and having a length that is long enough to encompass one or more filters 305A/305B stacked on top of each other on the camera lens). Step 125 allows for a diameter change between attachment section 105 and accessory section 115 for this purpose.

Rim lock camera lens accessory mount 100, as discussed above includes an accessory 135, which is implemented as a filter retainer accessory. Accessory 135 may be implemented as a rim which reduces a size of aperture 140 by a small amount, which is sufficient to prevent a camera filter 305A/305B from falling away from a camera lens. The rim may be integral to rim lock camera lens accessory mount 100.

Rim lock camera lens accessory mount 100 may optionally include a slit 120, which allows rim lock camera lens accessory mount 100 to flex due to its elastic properties to surround or mostly surround both a camera lens and one or more filters 305A/305B attached to the camera lens. As shown in FIG. 3, slit 120 is opened to a wider slit 120 to increase a diameter of rim lock camera lens accessory mount 100 both in attachment section 105 and accessory section 115 of rim lock camera lens accessory mount 100 such that half or more of a diameter of a camera lens is surrounded by rim lock camera lens accessory mount 100. For example, slit 120 may cause a diameter of rim lock camera lens accessory mount 100 to increase by 0-200% and anywhere in between to service camera lenses of a particular diameter, particularly those camera lenses that are 67 mm, 72 mm, 77 mm, and 82 mm. Rim lock camera lens accessory mount 100 may still be functional in maintaining one or more of camera filters 305A/305B in place when rim lock camera lens accessory mount 100 is stretched or slit 120 is expanded to twice its un-stressed or resting diameter. It is noted that due to the elasticity of the material used to create rim lock camera lens accessory mount 100, rim lock camera lens accessory mount 100 may naturally return to an un-stressed state as shown in FIG. 1 after use on a camera lens. It is further contemplated that slit 120 may be optional and that rim lock camera lens accessory mount 100 may be adapted to stretch over camera lens 300 for the same purpose and effect.

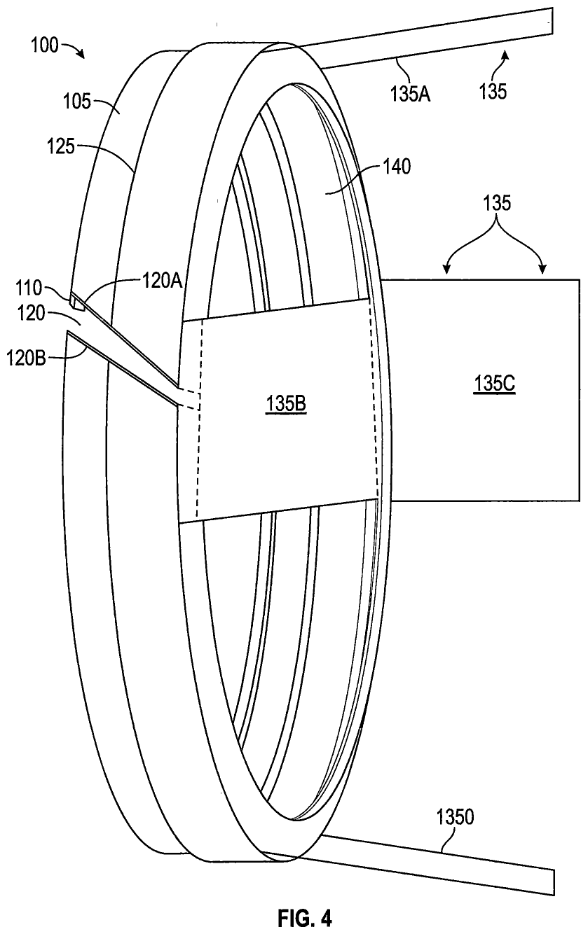

FIG. 4 illustrates a perspective view of rim rock camera lens accessory mount 100 implemented as a lens hood. Rim lock camera lens accessory mount 100 may generally be circular in construction which is useful in attaching rim lock camera lens accessory mount 100 to a camera lens. Since camera lenses are typically round in shape, rim lock camera lens accessory mount 100 may also be circular to attach around a circumference of a camera lens. Rim lock camera lens accessory mount 100 may be formed from synthetic materials with an element of elasticity, such as various plastics known in the art. For example, rim lock camera lens accessory mount 100 may have a particular diameter and may stretch, or separate, as will be discussed below, to attach to a camera lens having a diameter of double a resting (e.g., non-stretched or separated) diameter of rim lock camera lens accessory mount 100. Exemplary plastics may include silicone or other plastics known in the art that are suitable to stretch or separate to encompass a camera lens or at least mostly encompass a camera lens, as will be discussed below.

Rim lock camera lens accessory mount 100 may include an attachment section 105 and an accessory section 115. Attachment section 105 may further include a tongue or connector 110 (e.g., a tongue which matches a groove in a camera lens which operates as a connector between rim lock camera lens accessory mount 100 and a camera lens), that has a thickness 110A and a length 110B. Thickness 110A and length 110B may be compatible with a camera lens such that thickness 110A and length 110B correspond to a groove installed within a camera lens to secure rim lock camera lens accessory mount 100 to the camera lens. In one embodiment, thickness 110A and length 110B of tongue 110 may be commensurate with a bayonet mount, which is a type of mount known in the art of cameras. Tongue or connector 110, generally speaking, may interface with one or more corresponding elements installed on a camera lens to secure rim lock camera lens accessory mount 100 to rim lock camera lens accessory mount 100 to the camera lens.

Rim lock camera lens accessory mount 100 may include a step 125 disposed between attachment section 105 and accessory section 110. Attachment section 105 may be sized to attach to a camera lens while accessory section 115 may be fitted to accept a particular accessory 135 for a particular purpose. For example, as shown in FIG. 4, rim lock camera lens accessory mount 100 provides a lens hood accessory 135. To facilitate accessory 135 as a lens hood, accessory section 115 includes dimensions 130 that encompass one or more camera filters 305A/305B, shown in FIG. 3, which may be attached to a camera lens in terms of both diameter and length (e.g., having a diameter that may surround or mostly surround one or more camera filters and having a length that is long enough to encompass one or more filters stacked on top of each other on the camera lens) while also incorporating attached projections 135A, 135B, 135C, and 135D which function as a lens hood. Step 125 allows for a diameter change between attachment section 105 and accessory section 115 for this purpose. It is noted that one or more camera filters 305A/305B may not be necessary for a particular photographic situation and rim lock camera lens accessory mount 100 need not include dimensions 130 for providing other accessory functionality. In other words, a lens hood may be implemented without camera filters 305A/305B.

Rim lock camera lens accessory mount 100, as discussed above includes a lens accessory 135, which allows an operator to connect a lens hood to a camera lens with one or more camera filters 305A/305B installed on the camera lens. Lens hood 135 may be implemented as a plurality of protrusions 135A/135B which operate as a lens hood while also allowing the operator to use one or more camera filters 305A/305B and ensure that camera filters 305A/305B cannot inadvertently fall away from the camera lens.

Rim lock camera lens accessory mount 100 may optionally include a slit 120, which allows rim lock camera lens accessory mount 100 to flex due to its elastic properties to surround or mostly surround both a camera lens and one or more filters attached to the camera lens. As shown in FIG. 4, slit 120 may be cut such that each side of slit 120A and 120B are cut at approximately a 45 degree angle across rim lock camera lens accessory mount 100. Cutting slit 120 at a 45 degree angle allows for increased security in the connection between rim lock camera lens accessory mount 100 and the camera lens, while also allowing for additional flexibility over a straight slit 120, as shown in FIG. 1-3. However, slit 120 may still be opened to a wider slit to increase a diameter of rim lock camera lens accessory mount 100 both in attachment section 105 and accessory section 115 of rim lock camera lens accessory mount 100 such that half or more of a diameter of a camera lens is surrounded by rim lock camera lens accessory mount 100.

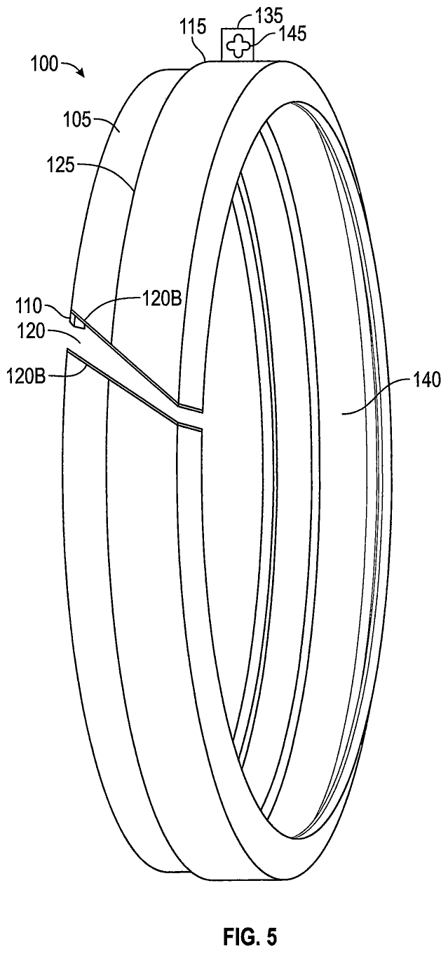

FIG. 5 illustrates a perspective view of a rim lock camera lens mount 100 implemented with a separate accessory mount 135. Rim lock camera lens accessory mount 100 may generally be circular in construction which is useful in attaching rim lock camera lens accessory mount 100 to a camera lens. Since camera lenses are typically round in shape, rim lock camera lens accessory mount 100 may also be circular to attach around a circumference of a camera lens. Rim lock camera lens accessory mount 100 may be formed from synthetic materials with an element of elasticity, such as various plastics known in the art. For example, rim lock camera lens accessory mount 100 may have a particular diameter and may stretch, or separate, as will be discussed below, to attach to a camera lens having a diameter of double a resting (e.g., non-stretched or separated) diameter of rim lock camera lens accessory mount 100. Exemplary plastics may include silicone or other plastics known in the art that are suitable to stretch or separate to encompass a camera lens or at least mostly encompass a camera lens, as will be discussed below.

Rim lock camera lens accessory mount 100 may include an attachment section 105 and an accessory section 115. Attachment section 105 may further include a tongue or connector 110 (e.g., a tongue which matches a groove in a camera lens which operates as a connector between rim lock camera lens accessory mount 100 and a camera lens), that has a thickness 110A and a length 110B. Thickness 110A and length 110B may be compatible with a camera lens such that thickness 110A and length 110B correspond to a groove installed within a camera lens to secure rim lock camera lens accessory mount 100 to the camera lens. In one embodiment, thickness 110A and length 110B of tongue 110 may be commensurate with a bayonet mount, which is a type of mount known in the art of cameras. Tongue or connector 110, generally speaking, may interface with one or more corresponding elements installed on a camera lens to secure rim lock camera lens accessory mount 100 to rim lock camera lens accessory mount 100 to the camera lens.

Rim lock camera lens accessory mount 100 may include a step 125 disposed between attachment section 105 and accessory section 110. Attachment section 105 may be sized to attach to a camera lens while accessory section 115 may be fitted to accept a particular accessory 135 for a particular purpose. For example, as shown in FIG. 5, rim lock camera lens accessory mount 100 provides an accessory mount 135. To facilitate accessory 135, accessory section 115 includes dimensions 130 that encompass one or more camera filters 305A/305B, shown in FIG. 3, which may be attached to a camera lens in terms of both diameter and length (e.g., having a diameter that may surround or mostly surround one or more camera filters and having a length that is long enough to encompass one or more filters stacked on top of each other on the camera lens) while also incorporating an accessory 135 as an accessory mount 135 with an accompanying fastener 145 for connecting the accessory to accessory mount 135. Step 125 allows for a diameter change between attachment section 105 and accessory section 115 for this purpose.

Rim lock camera lens accessory mount 100, as discussed above includes an accessory mount 135, which allows an operator to connect an accessory, such as a light, a video camera, or any other accessory which is useful in a photography scenario. Accessory mount 135 may be implemented using a more rigid material that may support the weight of an external accessory, such as a light, a camera lens protector, or a video camera, for example. It is noted that one or more camera filters 305A/305B may not be necessary for a particular photographic situation and rim lock camera lens accessory mount 100 need not include dimensions 130 for providing other accessory functionality. In other words, an accessory mount may be implemented without camera filters 305A/305B.

Rim lock camera lens accessory mount 100 may optionally include a slit 120, which allows rim lock camera lens accessory mount 100 to flex due to its elastic properties to surround or mostly surround both a camera lens and one or more filters attached to the camera lens. As shown in FIG. 4, slit 120 may be cut such that each side of slit 120A and 120B are cut at approximately a 45 degree angle relative to an axis defined by step 126 and across rim lock camera lens accessory mount 100. Cutting slit 120 at a 45 degree angle allows for increased security in the connection between rim lock camera lens accessory mount 100 and the camera lens, while also allowing for additional flexibility over a straight slit 120, as shown in FIG. 1-3. However, slit 120 may still be opened to a wider slit to increase a diameter of rim lock camera lens accessory mount 100 both in attachment section 105 and accessory section 115 of rim lock camera lens accessory mount 100 such that half or more of a diameter of a camera lens is surrounded by rim lock camera lens accessory mount 100.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A device, comprising:
an attachment section including a connector which extends around an inner circumference of the attachment section;
an accessory section connected by a step to the attachment section, the accessory section having dimensions which hold one or more accessories to a camera lens.

2. The device of claim 1, wherein the one or more accessories is a camera filter.

3. The device of claim 2, wherein the one or more accessories is a rim disposed around the accessory section.

4. The device of claim 2, wherein the one or more accessories includes a projection extending from the accessory section.

5. The device of claim 4, wherein the one or more accessories includes a plurality of projections extending from the accessory section.

6. The device of claim 2, wherein the accessory section further includes an accessory mount.

7. The device of claim 6, wherein the accessory mount connects to a video camera.

8. The device of claim 6, wherein the accessory mount connects to a light emitting device.

9. The device of claim 1, further comprising, a lens hood.

10. The device of claim 1, wherein the attachment section, the step, and the attachment section include a slit which is continuous through the attachment section, the step, and the accessory section.

11. The device of claim 8, wherein a first side of the slit and a second side of the slit are disposed at 45 degrees to an axis defined by the step.

12. The device of claim 1, wherein the attachment section, the step, and the accessory section are constructed to flex around a camera lens.

13. The device of claim 1, wherein the device expands circumferentially to enclose at least a portion of a camera lens.

14. The device of claim 1, wherein the connector interacts with a camera lens to secure the attachment section to the camera lens.

15. The device of claim 12, wherein the connector is a tongue which interacts with a groove in the camera lens.

16. The device of claim 1, wherein a diameter of the device is expandable to up to twice a diameter of the device in an un-stressed state.

17. The device of claim 1, wherein the attachment section connects to all of a 67 millimeter camera lens, a 72 millimeter camera lens, a 77 millimeter camera lens, and an 82 millimeter camera lens.

18. A device, comprising:
an attachment section including a connector,
an accessory section;
a slit extending through the attachment section and the accessory section, the attachment section connecting to all of a 67 millimeter camera lens, a 72 millimeter camera lens, a 77 millimeter camera lens, and an 82 millimeter camera lens.

19. The device of claim 18, further comprising a rim in the accessory section which secures one or more camera filters to a camera lens.

20. The device of claim 18, wherein the accessory section includes an accessory mount.
